(19) United States
(12) Patent Application Publication
(10) Pub. No.: US 2026/0288474 A1
(43) Pub. Date: Sep. 24, 2026

(54) MANAGING STARTUPS OF A DATA PROCESSING SYSTEM USING STATE INFORMATION

(71) Applicant: Dell Products L.P., Round Rock, TX (US)

(72) Inventors: IBRAHIM SAYYED, Georgetown, TX (US); ADOLFO SANDOR MONTERO, Pflugerville, TX (US); AMIT KUMAR TIWARI, Austin, TX (US)

(21) Appl. No.: 19/085,782

(22) Filed: Mar. 20, 2025

(51) Int. Cl. G06F 9/4401

(52) U.S. Cl. CPC G06F 9/4401

(57) ABSTRACT

Methods and systems for managing operations of a data processing system are disclosed. To manage operations of the data processing system, an occurrence of a startup event for the data processing system may be identified. Based on the identifying and using state information stored in a storage device of hardware resources of the data processing system, it may be identified whether a process initiated during a previous startup successfully completed. If the process did not successfully complete, performance of the process after a last successfully completed portion of the process may be attempted to be resumed. If the performance is successfully resumed, the process may be completed to place the data processing system in a desired state to facilitate provisioning of desired computer-implemented services.

### FIELD

Embodiments disclosed herein relate generally to managing operation of a data processing system. More particularly, embodiments disclosed herein relate to systems and methods to manage startups of a data processing system using state information.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show block diagrams illustrating a system in accordance with an embodiment.

FIG. 2 shows an interaction diagram in accordance with an embodiment.

FIG. 3 shows a flow diagram illustrating a method of managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware and/or software components that, in some combination, may be used to provide computer-implemented services. To provide the computer-implemented services, the data processing system may undergo a startup during which functionality of a portion of its hardware and/or software components may be enabled.

During the startup, a startup manager of the data processing system (e.g., a basic input/output system (BIOS)) may perform processes to place the data processing system in a desired operating state to provide the computer-implemented services. For example, the startup manager may perform firmware updates, diagnostic processes, repair processes, etc. The processes associated with the startup may be performed by the startup manager in sequence throughout the startup. Doing so may reduce a risk of compromise of the data processing system, errors occurring during startup, etc.

However, a portion of a process performed by the startup manager during the startup may be incomplete. As a result, the process may be initiated from a beginning portion of the process during a subsequent startup. In doing so, a portion of the process that successfully completed may be repeated during the subsequent startup.

The startup manager may have a limited capacity to perform the processes (e.g., due to its host hardware and/or program code) during the startup. For example, operation of the startup manager may be limited by a single processor that executes instructions one after the other in a specific order (e.g., as in sequential processing). Since each of the processes may also have some degree of time dependence, repeating portions of the processes may cause delays in completion of the startup. Such delays may consume an undesirable amount of computational and/or time resources, which may negatively affect the quality and/or availability of the computer-implemented services.

To reduce a resource consumption during the startup, state information may be collected by a management entity of the data processing system (e.g., the startup manager, a management controller of the data processing system) during the startup for a process. The state information may indicate successfully completed portions of the process. The state information may be stored (e.g., by the management entity) in a storage device of hardware resources of the data processing system. The storage device may include a boot partition, which may be a portion of storage resources of the storage device allocated for storage of boot data (e.g., such as the state information) usable to facilitate startups of the data processing system.

Upon identification of a startup event for the data processing system, the state information may be used to identify whether a process initiated during a previous startup successfully completed. If the process did not successfully complete during the previous startup, the state information may be used to attempt to resume performance of the process after a last successfully completed portion of the process. If the attempt to resume the performance of the process is successful, the process may be completed to place the data processing system in a desired state to facilitate provisioning of desired computer-implemented services. Doing so may allow the startup to be performed in a manner that reduces computational and time resources. As a result, the computer-implemented services may be provided to downstream consumers of the services as desired.

In an embodiment, a method for managing operation of a data processing system is disclosed. The method may include: identifying an occurrence of a startup event for the data processing system; based on the identifying the occurrence: identifying, using state information stored in a storage device of hardware resources of the data processing system, whether a process initiated during a previous startup successfully completed; in an instance of the identifying in which the process did not successfully complete during the previous startup: attempting, using the state information, to resume performance of the process after a last successfully completed portion of the process; and in a first instance of the attempting where the performance is successfully resumed: completing the process to place the data processing system in a desired state to facilitate provisioning of desired computer-implemented services.

The state information may be collected by a management entity of the data processing system during the previous startup while the process is being performed, and the state information may indicate successfully completed portions of the process.

The management entity may be a management controller of the data processing system, and the management controller may operate independently from and may be distinct from the hardware resources.

The method may also include: obtaining, by the management controller and via a first side band channel of the data processing system and during the previous startup, the state information from a processor of the data processing system; and providing, by the management controller and via a second side band channel of the data processing system, the state information to the storage device for storage of the state information to collect the state information.

The management controller may be adapted to collect the state information during the previous startup of the data processing system, and the hardware resources may be unable to persistently store the state information during the previous startup.

The last successfully completed portion of the process may be a portion of the process that does not need to be repeated for the performance of the process to resume and complete in an expected manner.

Attempting to resume the performance of the process after the last successfully completed portion of the process may include: identifying, using the state information and based on the last successfully completed portion of the process, an incomplete portion of the process; performing an analysis process to determine whether the data processing system is in a condition to successfully complete the incomplete portion of the process; and in an instance of the performing in which the data processing system is in the condition to successfully complete the incomplete portion of the process: initiating the attempting to resume the performance of the process after the last successfully completed portion of the process.

The method may also include: in a second instance of the attempting where the performance is not successfully resumed: updating the state information stored in the storage device to indicate that the data processing system is unable to complete the process so that future attempts to use the state information to complete the process are not made by the data processing system.

The state information may be stored in a boot partition of the storage device, the boot partition being a portion of storage resources of the storage device allocated for storage of boot data usable to facilitate startups of the data processing system.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

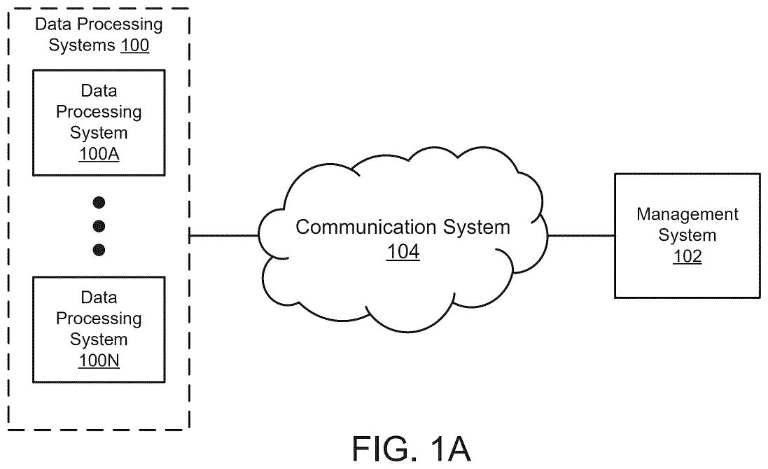

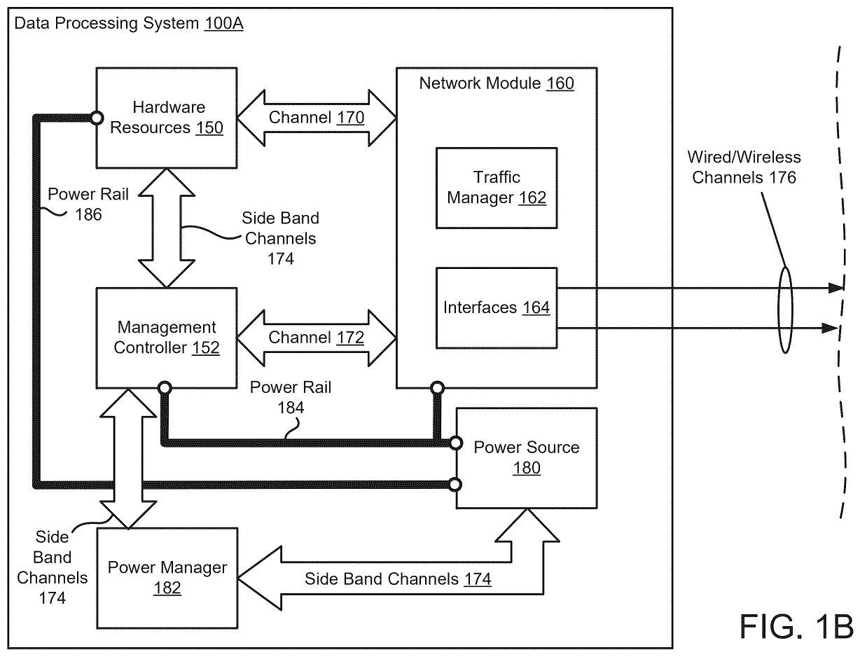

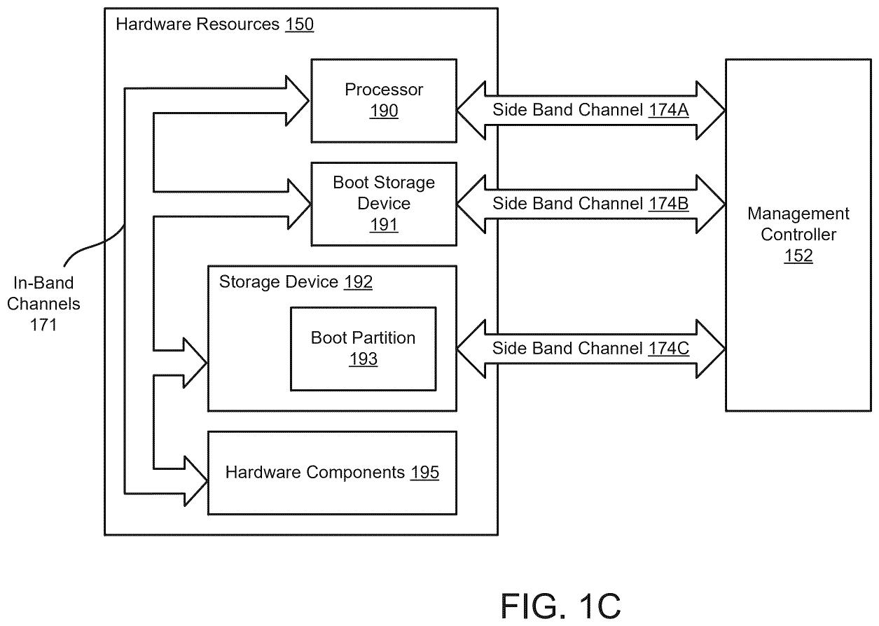

Turning to FIG. 1A, a block diagram illustrating a system in accordance with an embodiment is shown. The system shown in FIG. 1A may provide for management of any number of data processing systems (e.g., 100A-100N) that may provide, at least in part, computer-implemented services (e.g., to users of the system and/or devices operably connected to the system). The computer-implemented services may include any type and quantity of services including, for example, data services (e.g., data storage, access, and/or control services), communication services (e.g., instant messaging services, video-conferencing services), and/or any other type of service that may be implemented with a computing device. Other types of computer-implemented services may be provided by the system shown in FIG. 1A without departing from embodiments disclosed herein.

To provide the computer-implemented services, a data processing system system (e.g., 100A) may undergo a startup during which functionality of a portion of its hardware and/or software components may be enabled. For example, the computer-implemented services may require access to processors, memory modules, storage devices, communication devices, and/or other devices operably connected to the data processing system. The hardware components may support execution of any number and/or type of software components (e.g., applications), and, in some combination, the hardware and software components may provide for various types of computer-implemented services.

During the startup, a startup manager of the data processing system (e.g., a basic input/output system (BIOS)) may perform processes to place the data processing system in a desired operating state to provide the computer-implemented services. For example, the startup manager may perform firmware updates, diagnostic processes, repair processes, etc. The processes associated with the startup may be performed by the startup manager in sequence throughout the startup. Doing so may reduce a risk of compromise of the data processing system, errors occurring during startup, etc.

However, during performance of a process to place the data processing system in the desired operating state, a portion of the process may be incomplete. The portion of the process may be incomplete due to errors encountered while performing the process, the data processing system becoming unpowered during the performance of the process and/or other interruptions to the performance of the process. As a result, during a subsequent startup of the data processing system, the performance of the process may be initiated from a beginning portion of the process. In doing so, a portion of the process that successfully completed may be repeated during the subsequent startup.

The startup manager may have a limited capacity to perform the processes (e.g., due to its host hardware and/or program code). For example, operation of the startup manager may be limited by a single processor that executes instructions one after the other in a specific order (e.g., as in sequential processing). Since each of the processes may also have some degree of time dependence, repeating portions of the processes may cause delays in completion of the startup. Such delays may consume an undesirable amount of computational and/or time resources, which may negatively affect the quality and/or availability of the computer-implemented services.

In general, embodiments disclosed herein may provide methods, systems, and/or devices for managing operation of a data processing system in a manner that reduces a resource consumption during a startup of the data processing system. To do so, state information may be collected by a management entity of the data processing system during the startup for a process. The state information may indicate successfully completed portions of the process. The state information may be stored (e.g., by the management entity) in a storage device of hardware resources of the data processing system. The storage device may include a boot partition, which may be a portion of storage resources of the storage device allocated for storage of boot data (e.g., such as the state information) usable to facilitate startups of the data processing system.

Upon identification of a startup event for the data processing system, the state information may be used to identify whether a process initiated during a previous startup successfully completed. If the process did not successfully complete during the previous startup, the state information may be used to attempt to resume performance of the process after a last successfully completed portion of the process. If the attempt to resume the performance of the process is successful, the process may be completed to place the data processing system in a desired state to facilitate provisioning of desired computer-implemented services. Doing so may allow the startup to be performed in a manner that reduces computational and time resources.

The management entity may be hosted by in-band components (e.g., a BIOS hosted by a processor of the data processing system) and/or out-of-band components. The out-of-band components may include a management controller of the data processing system. The management controller may be distinct from and adapted to manage the hardware resources of the data processing system. For example, the management controller may manage startup processes performed by the BIOS hosted by the processor. By managing the startup processes using out-of-band methods, the startup processes may be performed as desired in instances when in-band methods are unavailable (e.g., due to a portion of the in-band components being unpowered, compromised, etc.).

To perform the above-mentioned functionality, the system of FIG. 1A may include data processing systems 100, and/or management system 102. Data processing systems 100, management system 102, any components thereof and/or any other types of devices or components not shown in FIG. 1A may perform all, or a portion of the computer-implemented services independently and/or cooperatively. Each of these components is discussed below.

Data processing systems 100 may include any number and type of data processing systems (e.g., 100A-100N) that may individually and/or cooperatively provide at least a portion of the computer-implemented services. Any of data processing systems 100 may include in-band components (e.g., hardware resources), out-of-band components (e.g., a management controller), and functionality that may allow the out-of-band components to communicate with management system 102 via an out-of-band communication channel.

While providing the at least the portion of the computer-implemented services, a data processing system (e.g., 100A) of data processing systems 100 may transmit and/or receive information from management system 102 (e.g., a remote system). For example, a management controller of data processing system 100A may communicate with management system 102 via an out-of-band communication channel. Using the out-of-band communication channel, the management controller may provide and obtain the information from management system 102 without traversing potentially compromised in-band communication channels. Doing so may reduce a risk of the information being obtained by a malicious and/or unauthorized entity, being unable to be obtained by data processing system 100A (e.g., due to the in-band components being powered off and/or otherwise inoperable), etc.

For example, the information obtained by the management controller of data processing system 100A from management system 102 may be usable to facilitate startups of data processing system 100A. The information may include policies, schemas, and/or other types of rule sets usable by a management entity of data processing system 100A (e.g., the management controller, the BIOS) during startups. For example, the information may include a policy that indicates a threshold number of times a process is to be attempted to be performed by data processing system 100A during a startup. Upon meeting the threshold, for example, the policy may indicate that data processing system 100A is not to continue attempting to perform the process.

Management system 102 may, as discussed above, provide remote management services for data processing systems 100. For example, as part of providing the remote management services, management system 102 may: (i) obtain diagnostic data such as error reports, service requests, and/or other information regarding undesired operation of data processing systems 100 (e.g., an inability to complete performance of a process during startup), (ii) provide, using the diagnostic data, support services for data processing systems 100 (e.g., provide remediation plans to data processing systems 100 based on the diagnostic data), and/or (iii) perform other tasks.

To provide the remote management services, management system 102 may include any number and/or type of devices (e.g., data processing systems) used to interact with data processing systems 100 to obtain and/or provide information (e.g., data) relevant to operation of data processing systems 100. Management system 102 may be implemented with multiple computing devices. The computing devices of management system 102 may cooperatively perform processes for providing the remote management services to data processing systems 100. The computing devices of management system 102 may perform similar and/or different functions, and may be used by different users (e.g., persons) that may participate in the management of data processing systems 100.

Management system 102 may be maintained, for example, by a business or other entity that has some degree of responsibility with respect to managing the operation of data processing systems 100. For example, management system 102 may be operated by a manufacturer of data processing systems 100 and/or a manufacturer of a portion of hardware resources of data processing systems 100.

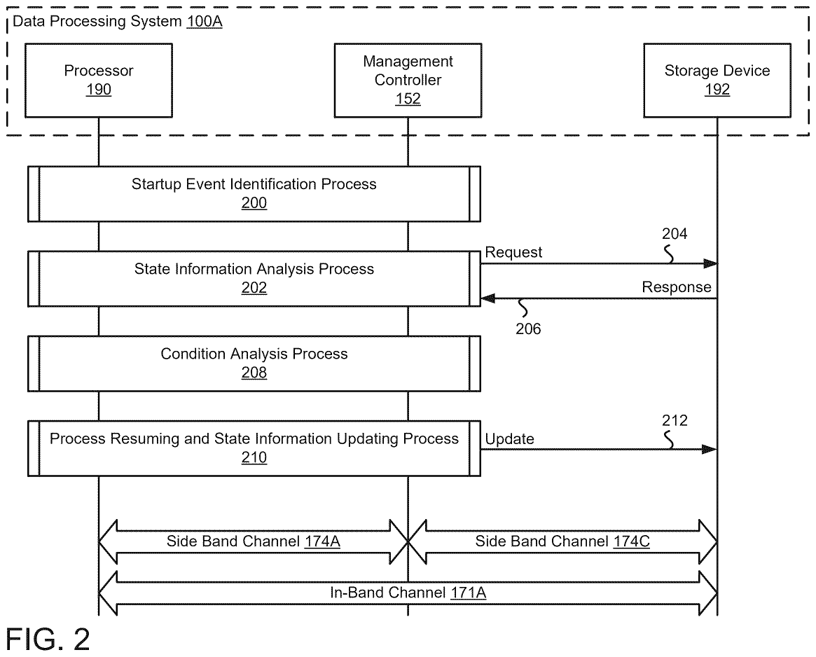

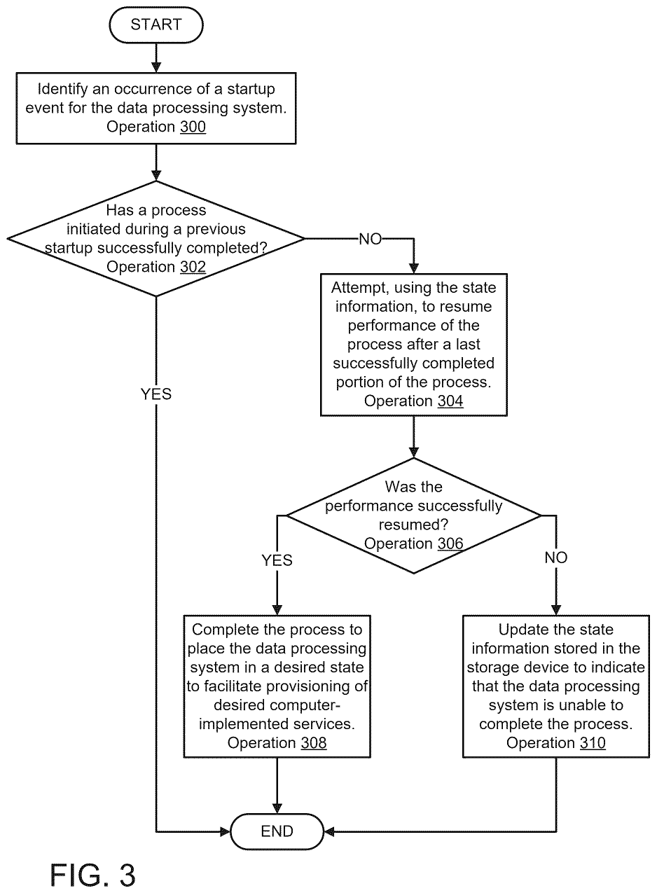

When providing their functionality, any of data processing systems 100 and/or management system 102 may perform all, or a portion of the actions and methods illustrated in FIGS. 2-3.

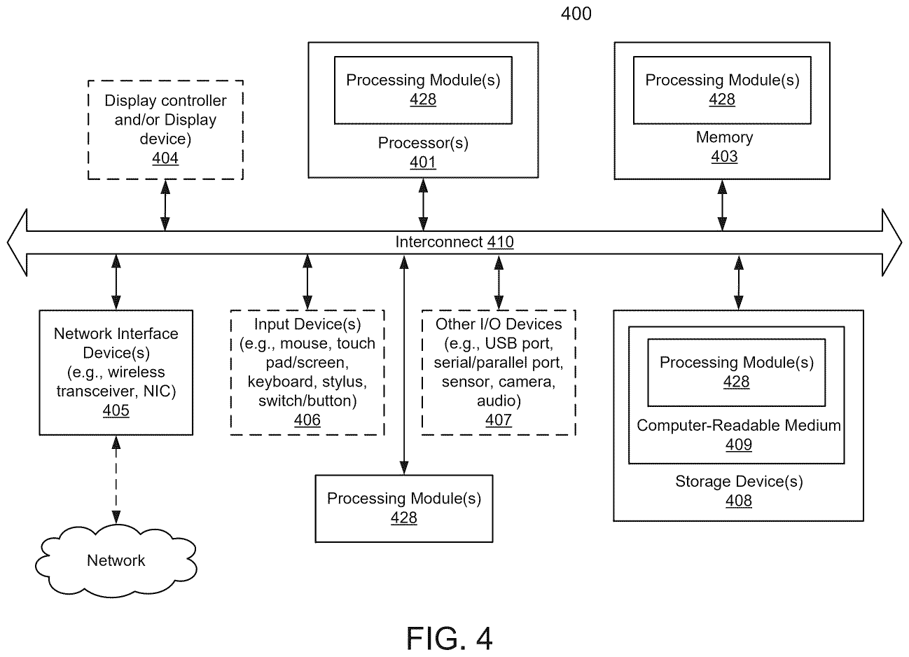

Any of data processing system 100 (and/or components thereof) and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 104. Communication system 104 may facilitate communications between the components of FIG. 1A. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 100A shown in FIG. 1B may be similar to any of data processing systems 100 shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., a basic input/output system (BIOS)), system configurations, and/or any other information. Additionally, the storage may include a second storage device that may include, but not be limited to, storage for information necessary to boot the data processing system, load an operating system for the data processing system, and/or perform any other processes (e.g., boot data).

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, may provide thermal management services, and/or may perform other functions of data processing system 100A.

To do so, management controller 152 may be operably connected to various components via side band channels 174 (in FIG. 1B, a limited number of side band channels are included for illustrative purposes, it will be appreciated that management controller 152 may communicate with other components via any number of sideband channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry and/or other types of diagnostic data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

For example, management controller 152 may participate in managing startups of data processing system 100A. To do so, management controller 152 may obtain state information for a process being performed during a startup by a processor of hardware resources 150 from the processor. Management controller 152 may obtain the state information via a first side band channel of data processing system 100A, and may provide the state information to a storage device of hardware resources 150 (e.g., a non-volatile memory express (NVMe) solid-state drive) via a second side band channel of data processing system 100A. During a subsequent startup, management controller 152 may obtain the state information from the storage device and provide the state information to the processor to facilitate the subsequent startup. Doing so may allow the state information to be used during startups, including in instances when in-band channels are unavailable.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any of management controller 152, entities hosted by management controller 152, and/or data managed by management controller 152.

To facilitate communication with other devices, such as the remote system, data processing system 100A may include network module 160. Network module 160 may provide communication services for in-band components and out-of-band components (e.g., management controller 152) of data processing system 100A. To do so, network module 160 may include traffic manager 162 and interfaces 164.

Traffic manager 162 may include functionality to: (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communicate with other devices (e.g., the remote system) while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2-3.

While illustrated in FIG. 1B with a limited number of specific components, a system may include additional, fewer, and/or different components without departing from embodiments disclosed herein.

Turning to FIG. 1C, to provide computer-implemented services by a data processing system (e.g., 100A), hardware resources 150 may host processor 190, boot storage device 191, storage device 192, and hardware components 195. Hardware components 195 may include any hardware resources of the data processing system, such as processors, memory modules, storage devices, and/or other types of hardware components usable to provide computer-implemented services.

To provide the computer-implemented services, the data processing system may undergo a booting process (e.g., a startup) to be placed in a desired operating state. During the booting process, hardware resources of the data processing system may be initialized to facilitate operation of an operating system (and/or other management entity of data processing system 100A), and/or other processes may be performed to place the data processing system in the desired operating state. To do so, processor 190 may execute instructions indicated by boot data (e.g., firmware, system configurations, etc.). The boot data may be hosted by boot storage device 191 and/or storage device 192.

Boot storage device 191 may include, for example, non-volatile flash memory (e.g., serial peripheral interface (SPI) flash) that may be hosted on a motherboard and adapted to store information, such as firmware, an image of a management entity (e.g., BIOS, universal extensible firmware interface (UEFI), etc.), system configuration files, and/or any other boot data usable to perform startups for data processing system 100A. Because boot storage device 191 may have a limited storage capacity, storage device 192 may be used to store additional information (e.g., other boot data, copies of boot data).

Storage device 192 may include, for example, a second storage device such as a non-volatile memory express (NVMe) solid-state drive. Storage device 192 may include a boot partition (e.g., 193) that may be a portion of storage resources of storage device 192 allocated for storage of boot data (e.g., a latest stable copy of the boot data, bootloader files, configuration files, etc.). For example, the boot data stored in boot partition 193 may include state information (e.g., data collected during performance of processes during startups indicating successfully completed portions of the processes). Boot partition 193 may, for example, be isolated from other memory sections of storage device 192.

While described with respect to boot partition 193 storing boot data, it will be appreciated that any other type of data may be stored in boot partition 193 without departing from embodiments disclosed herein.

Management controller 152 may operate independently from and may be distinct from hardware resources 150. To communicate with hardware resources 150 and implement management functionalities, management controller 152 may utilize side band channels (e.g., 174A-174C). For example, management controller 152 may communicate with storage device 192 via side band channel 174C. For additional details regarding management controller 152 and side band channels of the data processing system, refer to the description of FIG. 1B.

To execute instructions indicated by the boot data and/or perform processes using the boot data, hardware resources 150 may include processor 190. Processor 190 may include a central processing unit (CPU) and/or any other type of processor that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

Processor 190 may host any number and/or type of entities, which may include an operating system, drivers, applications, and/or any other type of software program that may provide computer-implemented services. As part of performing their functionality, the entities may perform operations with respect to at least a portion of hardware resources 150. For example, processor 190 may host a startup manager (e.g., a basic input/output system (BIOS)). The BIOS may facilitate management of the booting process of data processing system 100A from power on to booting to the operating system. To do so, the BIOS may perform processes related to device verification and initialization, and/or other processes related to enabling and/or securing hardware functionality. For example, the processes may include updating firmware, performing diagnostic processes (e.g., hardware exoneration), and/or performing repair processes (e.g., auto-heal functions).

To perform the processes, the BIOS may utilize boot data stored in boot storage device 191 and/or boot partition 193. To do so, processor 190 may obtain the boot data via in-band channels 171, and/or management controller 152 may provide the boot data to processor 190 via side band channel 174A. During the performance of the processes by the BIOS, the boot data (e.g., state information) may be updated. The boot data may be updated by: (i) providing updates by processor 190 to storage device 192 for storage in boot partition 193, and/or (ii) management controller 152 obtaining the updates from processor 190 and providing the updates to storage device 192. Refer to the description of FIG. 2 for additional details.

To further clarify embodiments disclosed herein, an interaction diagram in accordance with an embodiment is shown in FIG. 2. The interaction diagram may illustrate an example of how data may be obtained and used within the systems of FIGS. 1A-1C. In the example shown in FIG. 2, a data processing system (e.g., 100A) may include components such as hardware resources 150 and management controller 152. Hardware resources 150 may include processor 190 and storage device 192. The components of the data processing system may be similar to and/or include functionality similar to those described with respect to FIGS. 1A-1C.

In the interaction diagram, processes performed by and interactions between components of a system in accordance with an embodiment are shown. In the diagram, components of the system are illustrated using a first set of shapes (e.g., 152, 190, etc.), located towards the top of each figure. Lines descend from these shapes. Processes performed by the components of the system are illustrated using a second set of shapes (e.g., 200, 202, etc.) superimposed over these lines. Interactions (e.g., communication, data transmissions, etc.) between the components of the system are illustrated using a third set of shapes (e.g., 204, 206, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 206. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur during a startup of data processing system 100A (e.g., similar to data processing systems described in FIGS. 1A-1C) to place data processing system 100A in a desired state to facilitate provisioning of desired computer-implemented services.

To place data processing system 100A in the desired state, startup event identification process 200 may be performed. During startup event identification process 200, an occurrence of a startup event for data processing system 100A may be identified. For example, the occurrence of the startup event may be identified by processor 190 by receiving a reset signal (e.g., via a power-on process), and/or other instructions to begin performance of a startup of data processing system 100A.

Management controller 152 may monitor startup processes performed by processor 190, and may therefore also identify the occurrence of the startup event. For example, management controller 152 may: (i) monitor the startup processes via side band channel 174A, (ii) receive a notification and/or other information from processor 190 indicating the occurrence of the startup event, and/or (iii) otherwise identify the occurrence of the startup event.

During startup event identification process 200, processor 190 may perform startup tasks such as initializing registers, retrieving boot data to load a startup manager, executing instructions (e.g., firmware code) based on the boot data, and/or performing any other actions. The startup manager may include a BIOS, unified extensible firmware interface (UEFI), etc. and the boot data usable to load the startup manager may be stored on boot storage device 191 (not shown, refer to FIG. 1C). As a result, the startup manager hosted by processor 190 may begin performing processes to place data processing system 100A in the desired operating state and hand over management of data processing system 100A to an operating system (and/or other management entity).

To perform the processes to place data processing system 100A in the desired operating state, state information analysis process 202 may be performed. During state information analysis process 202, state information stored in storage device 192 may be obtained. The state information may have been collected by a management entity of data processing system 100A (e.g., the BIOS, management controller 152) during a previous startup of data processing system 100A for a process while the process was being performed. The process may include, for example: (i) firmware (flash) updates, (ii) diagnostic processes (e.g., diagnostic hardware exoneration), (iii) repair processes (e.g., auto-heal functions), and/or (iv) any other process that may be performed during the startup to place data processing system 100A in the desired operating state.

The state information may indicate: (i) successfully completed portions of the process (e.g., portions of the process which were executed as desired), (ii) portions of the process that were unable to be completed, (iii) information regarding errors encountered during the performance of the process, and/or (iv) other information. The state information may be stored, for example, as a binary large object (blob) and/or other type of data structure.

Each portion of the state information may indicate whether a portion of the process successfully completed, and may be stored in storage device 192 during the performance of the process. For example, upon successful completion of a first portion of the process, a data structure may be added to the state information to indicate the first portion of the process successfully completed. As each portion of the state information is added to storage device 192, a transaction hash may be included with the portion. The transaction hash may be mapped to the process being performed during the startup. In doing so, the state information may be used as a record of the progression of the performance of the process during the startup.

The state information may be stored in a boot partition (e.g., boot partition 193, refer to FIG. 1C) of storage device 192. The boot partition may be a portion of storage resources of storage device 192 allocated for storage of boot data, including the state information, usable to facilitate startups of data processing system 100A. For additional details regarding the boot partition and/or storage device 192, refer to the description of FIG. 1C.

The state information may be collected by, for example, management controller 152. Management controller 152 may be adapted to collect the state information during startups of data processing system 100A. Management controller 152 may collect the state information, for example, due to hardware resources of data processing system 100A being unable to persistently store the state information (e.g., the hardware resources may be unable to retain the state information after data processing system 100A is shut down, restarted, and/or otherwise powered off). For example, during startups of data processing system 100A, portions of the hardware resources and/or other in-band components may be unavailable (e.g., due to not being booted, due to errors, due to compromise). To improve a likelihood of the state information being retained, even in instances of an incomplete startup, management controller 152 may collect the state information.

To do so, management controller 152 obtain, via a first side band channel of data processing system 100A (e.g., side band channel 174A), the state information from processor 190 (e.g., by receiving the state information in a message from processor 190, by snooping and/or otherwise monitoring processes performed by processor 190). Management controller 152 may then provide, via a second side band channel of data processing system 100A (e.g., side band channel 174C), the state information to storage device 192 for storage of the state information. Management controller 152 may provide the state information to storage device 192 via a message, and the message may also include instructions for storage device 192 to store the state information in boot partition 193.

For example, during a first startup of data processing system 100A, the BIOS may attempt to perform a flash update process. The flash update process may include seven steps (e.g., portions), including: (i) initializing the flash update process, (ii) validating integrity and compatibility of new firmware, (iii) creating a backup of current firmware, (iv) erasing the current firmware from the flash memory, (v) writing the new firmware to the flash memory, (vi) verifying the new firmware has been written correctly, and (vii) finalizing the update and rebooting the system.

During performance of the flash update process, state information may be collected by the management entity. In a first example, the state information may be collected by management controller 152 by monitoring the performance of the flash update process by the BIOS and storing the state information in storage device 192. In a second example, the state information may be collected by the BIOS and/or other startup manager hosted by processor 190 and stored in storage device 192. The state information may include data regarding the progression of the flash update process. For example, as each step of the flash update process is successfully completed, data indicating that the step successfully completed may be stored as a binary large object (blob) in storage device 192.

During the first startup of data processing system 100A, the first two steps of the flash update process may successfully complete. However, an error may occur while performing the third step. For example, the error may occur due to a storage device intended to store the backup of the current firmware being unavailable (e.g., due to being powered off, not having sufficient available storage, experiencing an error, etc.). Consequently, the state information for the flash update process may indicate that the first two steps successfully completed. The state information may also indicate that the other five steps did not successfully complete.

The state information for a process performed during a previous startup of data processing system 100A may be obtained during state information analysis process 202 from storage device 192. The state information may be obtained: (i) by processor 190 and/or (ii) by management controller 152. To obtain the state information, a request may be provided (e.g., by processor 190, by management controller 152) at interaction 204. The request may be provided by (i) transmission via a message, (ii) storing in a storage with subsequent retrieval by storage device 192, (iii) a publish-subscribe system where storage device 192 subscribes to updates from management controller 152 and/or processor 190 thereby causing a copy of the request to be propagated to storage device 192, and/or (iv) other processes. The request may be provided by management controller 152 via side band channel 174C, and/or may be provided by processor 190 via in-band channel 171A.

Storage device 192 may read the request and obtain a response to the request, the response including the state information for the process. Storage device 192 may provide the response to management controller 152 and/or processor 190 at interaction 206 by (i) transmission via a message, (ii) storing in a storage with subsequent retrieval by management controller 152 and/or processor 190, (iii) a publish-subscribe system where management controller 152 and/or processor 190 subscribes to updates from storage device 192 thereby causing a copy of the response to be propagated to management controller 152 and/or processor 190, and/or (iv) other processes. The response may be provided to management controller 152 via side band channel 174C, and/or may be provided to processor 190 via in-band channel 171A.

The state information may be used by management controller 152 and/or the startup manager hosted by processor 190 to identify whether the process initiated during the previous startup successfully completed. For example, the state information may indicate: (i) each portion of the process that successfully completed during the previous startup, (ii) at least a portion of the process that did not successfully complete during the previous startup, (iii) that the process is unable to be completed (e.g., based on the condition of data processing system 100A and/or for other reasons) and is not to be attempted to be performed, and/or (iv) other information regarding performance of the process.

If no state information is able to be obtained for the process from storage device 192, the process may be performed from the beginning.

If the state information indicates that each portion of the process successfully completed during the previous startup, the process may be performed from the beginning (e.g., in instances where the process is to be repeated), and/or the process may not be performed (e.g., in instances where the process does not need to be repeated to place data processing system 100A in the desired operating state).

If the state information indicates that the process is unable to be completed: (i) the startup may proceed without performing the process, (ii) a notification may be provided to a remote management entity (e.g., management system 102, refer to FIG. 1A) via management controller 152 and/or another management entity of data processing system 100A indicating the process is unable to be completed, (iii) a user of data processing system 100A may be notified that the process is unable to be completed, and/or (iv) other actions may be performed.

If the state information indicates that at least a portion of the process did not successfully complete during the previous startup, the state information may be used to identify a last successfully completed portion of the process. The last successfully completed portion of the process may be a portion of the process that does not need to be repeated for the performance of the process to resume and complete in an expected manner. For example, state information may be obtained for a process having four portions performed sequentially (e.g., a first, second, third, and fourth portion). The state information may indicate that the first three portions completed successfully. Thus, the state information may be used to identify that the third portion is the last successfully completed portion.

While described with respect to the last successfully completed portion being the portion of the process last performed in a desired manner, it will be appreciated that a portion may be completed successfully during the previous startup and may have to be repeated for the process to resume and complete during the startup. For example, for the process having four portions for which the state information indicates the first three portions completed successfully, the third portion may be required to be repeated for the process to resume. In this example, the last successfully completed portion of the process may be the second portion.

If it is identified, using the state information, that the process initiated during the previous startup did not successfully complete, condition analysis process 208 may be performed. Condition analysis process 208 may be performed by management controller 152 and/or the startup manager hosted by processor 190. During condition analysis process 208, performance of the process may be attempted to be resumed after the last successfully completed portion of the process.

To do so, an incomplete portion of the process may be identified using the state information and based on the last successfully completed portion of the process. For example, the process may include three portions performed sequentially: a first portion, a second portion, and a third portion. The state information may indicate that the first portion and the second portion completed successfully. Based on the state information, it may be identified that the last successfully completed portion of the process is the second portion (e.g., the second portion may not need to be repeated for the process to resume and complete as desired). Thus, it may be identified that the incomplete portion of the process is the third portion.

An analysis process may then be performed to determine whether data processing system 100A is in a condition to successfully complete the incomplete portion of the process. For example, the analysis process may be performed to determine whether data processing system 100A meets requirements to successfully complete the incomplete portion. Performing the analysis process may include: (i) identifying, based on the incomplete portion of the process, any hardware and/or software components necessary to perform the incomplete portion, (ii) making a determination regarding whether the identified hardware and/or software components are available (e.g., powered on, operating as desired) for performance of the incomplete portion of the process, (iii) identifying whether data processing system 100A meets other requirements for performance of the incomplete portion of the process (e.g., data processing system 100A meets temperature, power, and/or other requirements), and/or (iv) other methods.

If it is determined that data processing system 100A meets the requirements for performance of the incomplete portion, data processing system 100A may be in the condition to successfully complete the incomplete portion of the process. If it is determined that data processing system 100A does not meet the requirements for performance of the incomplete portion, data processing system 100A may not be in the condition to successfully complete the incomplete portion of the process.

For example, it may be identified that the incomplete portion of the process is the third portion. To successfully complete the third portion, a storage device of data processing system 100A may be required to be available (e.g., powered on). The management entity of data processing system 100A (e.g., the startup manager and/or management controller 152) may determine whether the storage device is available. If it is determined that the storage device is available, data processing system 100A may be in the condition to perform the third portion of the process. If it is determined that the storage device is unavailable, data processing system 100A may not be in the condition to perform the third portion of the process.

If it is determined that data processing system 100A is not in the condition to successfully complete the incomplete portion of the process, the management entity may not initiate the attempt to resume performance of the process. The management entity may: (i) continue performance of the startup without performing the process, (ii) provide a notification to a remote management entity (e.g., management system 102, refer to FIG. 1A) indicating the process is unable to be completed, (iii) provide a notification to a user of data processing system 100A indicating that the process is unable to be completed, and/or (iv) other actions may be performed.

If it is determined that data processing system 100A is in the condition to successfully complete the incomplete portion of the process, process resuming and state information updating process 210 may be performed. During process resuming and state information updating process 210, the attempt to resume the performance of the process may be initiated by the management entity after the last successfully completed portion of the process. For example, initiating the attempt to resume performance of the process may include management controller 152 providing instructions to processor 190 via side band channel 174A. The instructions may indicate that the performance of the process is to be resumed after the last successfully completed portion of the process (e.g., which may be specified in the instructions provided by management controller 152).

For example, the process may include a first portion, a second portion, and a third portion, and the second portion may be the last successfully completed portion. If data processing system 100A is in the condition to successfully complete performance of the third portion, an attempt to resume performance of the process by performing the third portion may be initiated.

If the performance of the process is successfully resumed, the process may be completed to place data processing system 100A in a desired state to facilitate provisioning of the desired computer-implemented services. For example, completing the process may include performing the incomplete portion of the process. Data processing system 100A may then be placed in the desired state.

While completing the process, the state information stored in storage device 192 may be updated. For example, management controller 152 and/or processor 190 may provide the update to the state information at interaction 212. The update may indicate: (i) successfully completed portions of the process, (ii) portions of the process that were unable to be successfully completed, (iii) errors encountered during the performance of the process, and/or (iv) other information. For example, the update may indicate that the incomplete portion was successfully completed, and therefore the process was successfully completed.

If performance of the process is not successfully resumed, the state information stored in storage device 192 may be updated at interaction 212 to indicate that data processing system 100A is unable to complete the process. By doing so, future attempts to use the state information to complete the process (e.g., during subsequent startups) may not be made by data processing system 100A. For example, a threshold number of times the process is unsuccessfully performed may be limited by a policy (e.g., obtained from a remote management entity and/or any other entity). After the threshold number of times is met, the state information may indicate that the process is not to be attempted during future startups (e.g., until a root cause for the unsuccessful performance is addressed). Doing so may reduce a resource consumption for repeating performance of a process that is unable to be successfully completed by data processing system 100A.

The update to the state information may be provided to storage device 192 by management controller 152 and/or processor 190 by (i) transmission via a message, (ii) storing in a storage with subsequent retrieval by storage device 192, (iii) a publish-subscribe system where storage device 192 subscribes to updates from management controller 152 and/or processor 190 thereby causing a copy of the update to be propagated to storage device 192, and/or (iv) other processes. The update may be provided by management controller 152 via side band channel 174C, and/or may be provided by processor 190 via in-band channel 171A.

Thus, the processes and interactions shown in FIG. 2 may be used during a startup of a data processing system to complete performance of a process initiated during a previous startup of the data processing system. To do so, state information stored in a boot partition of a storage device (e.g., an NVMe solid-state drive) may be used to identify: (i) whether a process was initiated during the previous startup, and (ii) a last successfully completed portion of the process. The process may be attempted to be resumed after the last successfully completed portion. Doing so may conserve time and computational resources during the startup by resuming the process rather than restarting the process, and/or not performing processes for which the state information indicates are not to be performed. Consequently, the resources may be used in the provisioning of the computer-implemented services.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2 may perform various methods to manage the operation of data processing systems. FIG. 3 illustrates a method that may be performed by the components of the system of FIGS. 1A-2. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system, any component of a data processing system (e.g., a management controller, hardware resources) and/or another device.

Turning to FIG. 3, a flow diagram illustrating a method in accordance with an embodiment is shown. The flow diagram may illustrate various operations performed while managing operation of a data processing system. The data processing system may include hardware resources and a management controller, and may be similar to the data processing system discussed with respect to FIGS. 1A-1C.

At operation 300, an occurrence of a startup event for the data processing system may be identified. The startup event may be identified by a management entity of the data processing system, such as a startup manager (e.g., a BIOS, UEFI, and/or other entity hosted by a processor of the data processing system) and/or a management controller of the data processing system. Identifying the occurrence of the startup event may include: (i) receiving a reset signal (e.g., via a power-on process) by the processor, (ii) receiving other instructions by the processor to initiate performance of the startup, (iii) monitoring, by the management controller, the operational state of the processor, (iv) identifying, by the management controller and based on the operational state of the processor, that the startup is being initiated, (v) receiving, by the management controller, a message from the processor indicating the startup is being initiated, and/or (vi) other methods.

At operation 302, it may be identified, using state information stored in a storage device of hardware resources of the data processing system, whether a process initiated during a previous startup successfully completed. The state information may be collected during the previous startup by the management entity (e.g., the startup manager, the management controller). For example, collecting the state information by the management controller during the previous startup may include: (i) obtaining, by the management controller and via a first side band channel of the data processing system, the state information from the processor of the data processing system, (ii) providing, by the management controller and via a second side band channel of the data processing system, the state information to the storage device for storage of the state information, and/or (iii) other methods.

Obtaining the state information from the processor may include: (i) snooping and/or monitoring processes performed by the processor to obtain the state information based on the processes, (ii) receiving the state information from the processor via a message, (iii) reading the state information from a storage used by the processor to store the state information, and/or (iv) other methods.

Providing the state information to the storage device for storage of the state information may include: (i) transmitting the state information to the storage device via a message, (ii) storing the state information in another storage with subsequent retrieval by the storage device, (iii) providing the state information to another entity responsible for providing the state information to the storage device, and/or (iv) other methods.

Identifying whether the process initiated during the previous startup successfully completed using the state information (e.g., from the previous startup) may include: (i) obtaining the state information, (ii) performing an analysis process for the state information to determine whether each portion of the process successfully completed (e.g., parsing the state information to determine whether the state information indicates each portion of the process successfully completed), (iii) receiving a message from another entity indicating whether the process initiated during the previous startup successfully completed, and/or (iv) other methods.

Obtaining the state information may include: (i) obtaining the state information by the management controller from the storage device via a side band channel of the data processing system, (ii) providing, by the management controller, the state information to the processor via a side band channel of the data processing system, (iii) obtaining the state information by the processor from the storage device via an in-band channel of the data processing system, and/or (iv) other methods.

If it is determined that the process initiated during the previous startup successfully completed (e.g., the determination is “Yes” at operation 302), then the method may end. The startup may proceed in a usual manner.

Returning to operation 302, if it is determined that the process initiated during the previous startup did not successfully complete (e.g., the determination is “No” at operation 302), then the method may proceed to operation 304.

At operation 304, it may be attempted, using the state information, to resume performance of the process after a last successfully completed portion of the process. Attempting to resume performance of the process may include: (i) identifying, using the state information and based on the last successfully completed portion of the process, an incomplete portion of the process, (ii) performing an analysis process to determine whether the data processing system is in a condition to successfully complete the incomplete portion of the process, (iii) in an instance of the performing in which the data processing system is in the condition to successfully complete the incomplete portion of the process: initiating the attempting to resume the performance of the process after the last successfully completed portion of the process, (iv) in a second instance of the performing in which the data processing system is not in the condition to successfully complete the incomplete portion of the process: updating the state information to indicate that the data processing system is not in the condition to successfully complete the incomplete portion of the process (e.g., providing an update to the state information to the storage device, providing the update to another entity responsible for providing the update to the storage device, storing the update in another storage with subsequent retrieval by the storage device), and/or (v) other methods.

Identifying the incomplete portion of the process may include: (i) identifying the last successfully completed portion of the process, (ii) identifying, based on the last successfully completed portion of the process, a portion of the process that did not successfully complete and is thus the incomplete portion, (iii) parsing the state information to determine the incomplete portion (e.g., the state information may indicate the incomplete portion), (iv) receiving an indication of the incomplete portion from another entity, and/or (v) other methods.

Performing the analysis process may include: (i) identifying, based on the incomplete portion of the process, any hardware and/or software components necessary to perform the incomplete portion, (ii) making a determination regarding whether the identified hardware and/or software components are available (e.g., powered on, operating as desired) for performance of the incomplete portion of the process, (iii) identifying whether the data processing system meets other requirements for performance of the incomplete portion of the process (e.g., whether the data processing system meets temperature, power, and/or other requirements), (iv) providing the state information to another entity responsible for performing the analysis process and receiving an indication regarding whether the data processing system is in the condition to successfully complete the incomplete portion of the process in response to the providing, and/or (v) other methods.

Initiating the attempting to resume the performance of the process after the last successfully completed portion of the process may include: (i) providing, by the management controller, a message to the processor, the message including instructions for resuming the process after the last successfully completed portion of the process, (ii) continuing to perform the process after the last successfully completed portion of the process, (iii) receiving instructions to resume the performance of the process after the last successfully completed portion of the process from another entity, and/or (iv) other methods.

At operation 306, it may be determined whether the performance was successfully resumed. Determining whether the performance was successfully resumed may include: (i) identifying whether performance of the incomplete portion of the process was able to be initiated (e.g., based on whether the data processing system is in the condition to perform the incomplete portion), (ii) receiving an indication that the performance was successfully resumed from another entity, and/or (iii) other methods.

If it is determined that the performance is successfully resumed (e.g., the determination is “Yes” at operation 306), then the method may proceed to operation 308.

At operation 308, the process may be completed to place the data processing system in a desired state to facilitate provisioning of desired computer-implemented services. Completing the process may include: (i) performing the incomplete portion of the process, (ii) providing the desired computer-implemented services while the data processing system is in the desired state, and/or (iii) other methods.

The method may end following operation 308.

Returning to operation 306, if it is determined that the performance is not successfully resumed (e.g., the determination is “No” at operation 306), then the method may proceed to operation 310.

At operation 310, the state information stored in the storage device may be updated to indicate that the data processing system is unable to complete the process so that future attempts to use the state information to complete the process are not made by the data processing system. Updating the state information may include: (i) providing an update for the state information and/or other instructions regarding updating the state information to the storage device by the management entity via a message, (ii) storing the update in another storage followed by retrieval of the update by the storage device, (iii) providing the update to another entity responsible for providing the update to the storage device, and/or (iv) other methods.

The method may end following operation 310.

Thus, as illustrated above, embodiments disclosed herein may provide systems and methods usable to facilitate startups of a data processing system in a manner that reduces a resource consumption during the startup. The resource consumption may be reduced by resuming performance of an incomplete process initiated during a previous startup of the data processing system (e.g., the process may not need to be restarted from the beginning). To do so, state information for the process may be stored in a storage device of the data processing system (e.g., an NVMe solid-state drive). The state information may then be used in subsequent startups. As a result, the resources may be used for provisioning of the desired computer-implemented services.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying an occurrence of a startup event for the data processing system;
based on the identifying of the occurrence:
identifying, using state information stored in a storage device of hardware resources of the data processing system, whether a process initiated during a previous startup successfully completed;
in an instance of the identifying in which the process did not successfully complete during the previous startup:
attempting, using the state information, to resume performance of the process after a last successfully completed portion of the process; and
in a first instance of the attempting where the performance is successfully resumed:
completing the process to place the data processing system in a desired state to facilitate provisioning of desired computer-implemented services.

2. The method of claim 1, wherein the state information is collected by a management entity of the data processing system during the previous startup while the process is being performed, and the state information indicates successfully completed portions of the process.

3. The method of claim 2, wherein the management entity is a management controller of the data processing system, the management controller operating independently from and being distinct from the hardware resources.

4. The method of claim 3, further comprising:
obtaining, by the management controller and via a first side band channel of the data processing system and during the previous startup, the state information from a processor of the data processing system; and
providing, by the management controller and via a second side band channel of the data processing system, the state information to the storage device for storage of the state information to collect the state information.

5. The method of claim 4, wherein the management controller is adapted to collect the state information during the previous startup of the data processing system, and the hardware resources are unable to persistently store the state information during the previous startup.

6. The method of claim 1, wherein the last successfully completed portion of the process is a portion of the process that does not need to be repeated for the performance of the process to resume and complete in an expected manner.

7. The method of claim 1, wherein attempting to resume the performance of the process after the last successfully completed portion of the process comprises:
identifying, using the state information and based on the last successfully completed portion of the process, an incomplete portion of the process;
performing an analysis process to determine whether the data processing system is in a condition to successfully complete the incomplete portion of the process; and
in an instance of the performing in which the data processing system is in the condition to successfully complete the incomplete portion of the process:
initiating the attempting to resume the performance of the process after the last successfully completed portion of the process.

8. The method of claim 1, further comprising:
in a second instance of the attempting where the performance is not successfully resumed:
updating the state information stored in the storage device to indicate that the data processing system is unable to complete the process so that future attempts to use the state information to complete the process are not made by the data processing system.

9. The method of claim 1, wherein the state information is stored in a boot partition of the storage device, the boot partition being a portion of storage resources of the storage device allocated for storage of boot data usable to facilitate startups of the data processing system.

10. A non-transitory machine-readable medium having instructions stored therein, which when executed by a processor, cause the processor to perform operations for managing operation of a data processing system, the operations comprising:
identifying an occurrence of a startup event for the data processing system;
based on the identifying of the occurrence:
identifying, using state information stored in a storage device of hardware resources of the data processing system, whether a process initiated during a previous startup successfully completed;
in an instance of the identifying in which the process did not successfully complete during the previous startup:
attempting, using the state information, to resume performance of the process after a last successfully completed portion of the process; and
in a first instance of the attempting where the performance is successfully resumed:
completing the process to place the data processing system in a desired state to facilitate provisioning of desired computer-implemented services.

11. The non-transitory machine-readable medium of claim 10, wherein the state information is collected by a management entity of the data processing system during the previous startup while the process is being performed, and the state information indicates successfully completed portions of the process.

12. The non-transitory machine-readable medium of claim 11, wherein the management entity is a management controller of the data processing system, the management controller operating independently from and being distinct from the hardware resources.

13. The non-transitory machine-readable medium of claim 12, further comprising:
obtaining, by the management controller and via a first side band channel of the data processing system and during the previous startup, the state information from a processor of the data processing system; and
providing, by the management controller and via a second side band channel of the data processing system, the state information to the storage device for storage of the state information to collect the state information.

14. The non-transitory machine-readable medium of claim 13, wherein the management controller is adapted to collect the state information during the previous startup of the data processing system, and the hardware resources are unable to persistently store the state information during the previous startup.

15. The non-transitory machine-readable medium of claim 10, wherein the last successfully completed portion of the process is a portion of the process that does not need to be repeated for the performance of the process to resume and complete in an expected manner.

16. A data processing system, comprising:
a processor; and
a memory coupled to the processor to store instructions, which when executed by the processor, cause the processor to perform operations for managing operation of a data processing system, the operations comprising:
identifying an occurrence of a startup event for the data processing system;
based on the identifying of the occurrence:
identifying, using state information stored in a storage device of hardware resources of the data processing system, whether a process initiated during a previous startup successfully completed;
in an instance of the identifying in which the process did not successfully complete during the previous startup:
attempting, using the state information, to resume performance of the process after a last successfully completed portion of the process; and
in a first instance of the attempting where the performance is successfully resumed:
completing the process to place the data processing system in a desired state to facilitate provisioning of desired computer-implemented services.

17. The data processing system of claim 16, wherein the state information is collected by a management entity of the data processing system during the previous startup while the process is being performed, and the state information indicates successfully completed portions of the process.

18. The data processing system of claim 17, wherein the management entity is a management controller of the data processing system, the management controller operating independently from and being distinct from the hardware resources.

19. The data processing system of claim 18, further comprising:
obtaining, by the management controller and via a first side band channel of the data processing system and during the previous startup, the state information from a processor of the data processing system; and
providing, by the management controller and via a second side band channel of the data processing system, the state information to the storage device for storage of the state information to collect the state information.

20. The data processing system of claim 19, wherein the management controller is adapted to collect the state information during the previous startup of the data processing system, and the hardware resources are unable to persistently store the state information during the previous startup.
